(19) United States
(12) Patent Application Publication
(10) Pub. No.: US 2021/0237245 A1
(43) Pub. Date: Aug. 5, 2021

(54) FASTENER DRIVING TOOL

(71) Applicant: HILTI AKTIENGESELLSCHAFT, Schaan (LI)

(72) Inventor: Tilo DITTRICH, Feldkirch (AT)

(21) Appl. No.: 17/051,971

(22) PCT Filed: Jun. 5, 2019
(86) PCT No.: PCT/EP2019/064624

§ 371 Date: Oct. 30, 2020

(30) Foreign Application Priority Data
Jun. 6, 2018 (EP) 18176201.4

(51) Int. Cl. B25C 1/06; B25C 1/04

(52) U.S. Cl. CPC B25C 1/06; B25C 1/04

(57) ABSTRACT

A setting tool for driving fastening elements into a substrate, comprising a holder, which is provided for holding a fastening element, a drive-in element, which is provided for transferring a fastening element held in the holder into the substrate along a setting axis, the drive-in element having a piston plate and a piston rod, a drive, which is provided for driving the drive-in element toward the fastening element along the setting axis, a guide cylinder, in which the piston plate is guided along the setting axis, and passages, through which air escapes from the cylinder.

The present invention relates to a setting tool for driving fastening elements into a substrate.

Such setting tools usually have a holder for a fastening element, from which a fastening element held therein is transferred into the substrate along a setting axis. For this, a drive-in element is driven toward the fastening element along the setting axis by a drive.

U.S. Pat. No. 6,830,173 B2 discloses a setting tool with a drive for a drive-in element. The drive has an electrical capacitor and a coil. For driving the drive-in element, the capacitor is discharged via the coil, whereby a Lorentz force acts on the drive-in element, so that the drive-in element is moved toward a nail.

The object of the present invention is to provide a setting tool of the aforementioned type with which high efficiency and/or good setting quality are ensured.

The object is achieved by a setting tool for driving fastening elements into a substrate, comprising a holder, which is provided for holding a fastening element, a drive-in element, which is provided for transferring a fastening element held in the holder into the substrate along a setting axis, a drive, which is provided for driving the drive-in element toward the fastening element along the setting axis, and a guide cylinder, in which the drive-in element is guided along the setting axis, a lateral surface of the guide cylinder having one or more non-closable openings. The openings ensure ventilation of the guide cylinder, as a result of which a dynamic pressure in front of the drive-in element and/or a suction pressure behind the drive-in element and a concomitant loss of energy are reduced. The setting tool can in this case preferably be used in a hand-held manner. Alternatively, the setting tool can be used in a stationary or semi-stationary manner.

In the context of the invention, a capacitor should be understood as meaning an electrical component that stores electrical charge and the associated energy in an electrical field. In particular, a capacitor has two electrically conducting electrodes, between which the electrical field builds up when the electrodes are electrically charged differently. In the context of the invention, a fastening element should be understood as meaning for example a nail, a pin, a clamp, a clip, a stud, in particular a threaded bolt, or the like.

An advantageous embodiment is characterized in that at least one of the one or more non-closable openings comprises a slot. A longitudinal direction of the slot parallel to the setting axis is preferred. Alternatively, a longitudinal direction of the slot is inclined with respect to the setting axis.

An advantageous embodiment is characterized in that an extent of at least one of the one or more openings in the direction of the setting axis is greater than transversely to the setting axis.

An advantageous embodiment is characterized in that the lateral surface has a number of non-closable openings, which are distributed along the setting axis.

An advantageous embodiment is characterized in that the drive-in element comprises a piston plate and a piston rod, the piston plate being guided in the guide cylinder. In the direction of the setting axis, the holder is preferably arranged in front of the piston rod and the piston plate behind the piston rod.

An advantageous embodiment is characterized in that the guide cylinder has a front end portion on its side facing the holder, all non-closable openings being arranged outside the front end portion, and a closed front cavity being formed in the front end portion when the drive-in element, preferably its piston plate, is located in the front end portion. The guide cylinder preferably has a front check valve, which allows an air flow into the front cavity and blocks an air flow out of the front cavity.

An advantageous embodiment is characterized in that the guide cylinder has a rear end portion on its side facing away from the holder, all non-closable openings being arranged outside the rear end portion, and a closed rear cavity being formed in the rear end portion when the drive-in element, preferably its piston plate, is located in the rear end portion. The guide cylinder preferably has a rear check valve, which allows an air flow into the rear cavity and blocks an air flow out of the rear cavity.

An advantageous embodiment is characterized in that the drive has an electrical capacitor, a squirrel-cage rotor arranged on the drive-in element and an excitation coil, which during discharge of the capacitor is flowed through by current and generates a magnetic field that accelerates the drive-in element toward the fastening element.

The invention is represented in a number of exemplary embodiments in the drawings, in which:

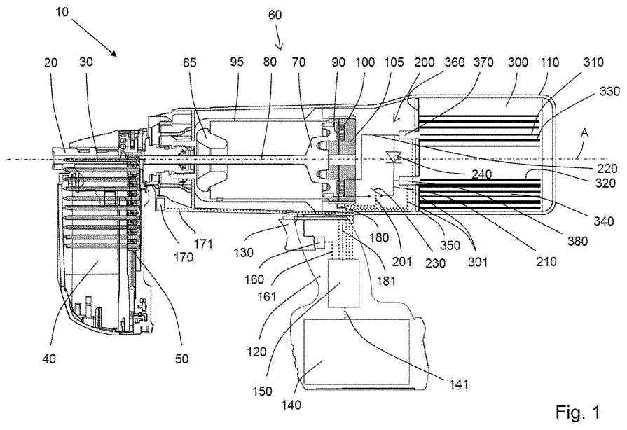

FIG. 1 shows a longitudinal section through a setting tool,

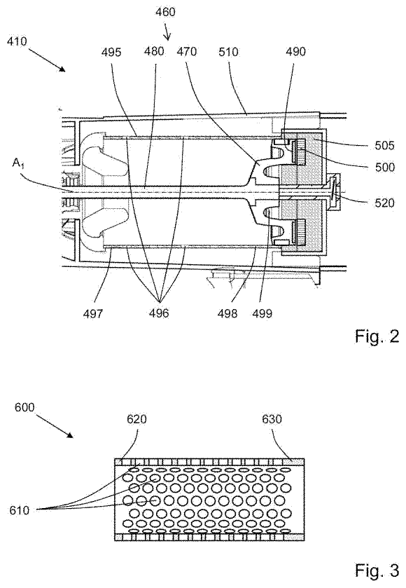

FIG. 2 shows a longitudinal section through a setting tool in the form of a detail,

FIG. 3 shows a longitudinal section through a guide cylinder,

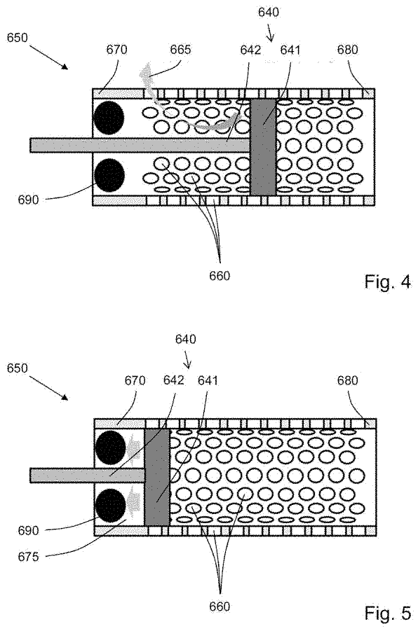

FIG. 4 shows a longitudinal section through a drive-in element in a guide cylinder,

FIG. 5 shows a longitudinal section through a drive-in element in a guide cylinder,

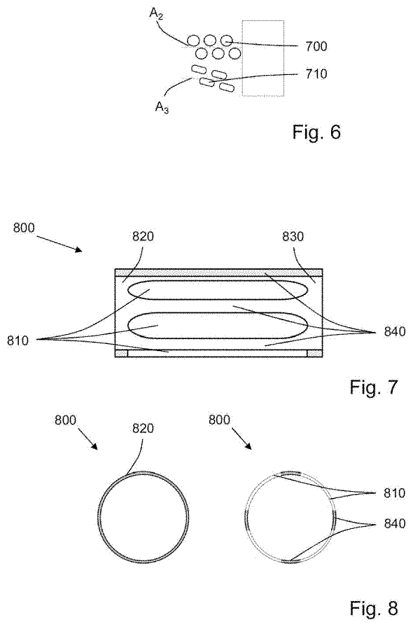

FIG. 6 shows two variants of openings in a guide cylinder,

FIG. 7 shows a longitudinal section through a guide cylinder,

FIG. 8 shows a cross section through a guide cylinder in two different axial positions,

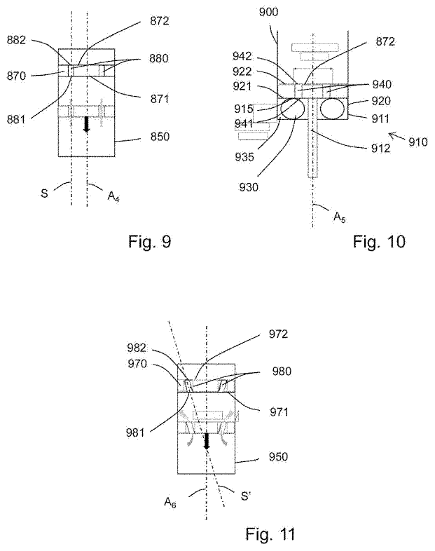

FIG. 9 shows a longitudinal section through a drive-in element in a guide cylinder,

FIG. 10 shows a longitudinal section through a drive-in element in a guide cylinder,

FIG. 11 shows a plan view and a longitudinal section through a drive-in element in a guide cylinder,

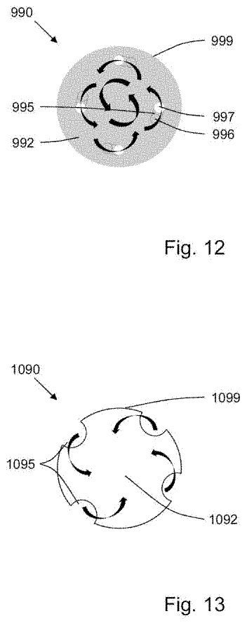

FIG. 12 shows a plan view of a piston plate and

FIG. 13 shows a plan view of a piston plate.

FIG. 1 illustrates a hand-held setting tool 10 for driving fastening elements into a substrate that is not shown. The setting tool 10 has a holder 20 formed as a stud guide, in which a fastening element 30, which is formed as a nail, is held in order to be driven into the substrate along a setting axis A (to the left in FIG. 1). For the purpose of supplying fastening elements to the holder, the setting tool 10 comprises a magazine 40 in which the fastening elements are held in store individually or in the form of a fastening element strip 50 and are transported to the holder 20 one by one. To this end, the magazine 40 has a spring-loaded feed element, not specifically denoted. The setting tool 10 has a drive-in element 60, which comprises a piston plate 70 and a piston rod 80. The drive-in element 60 is provided for transferring the fastening element 30 out of the holder 20 along the setting axis A into the substrate. In the process, the drive-in element 60 is guided with its piston plate 70 in a guide cylinder 95 along the setting axis A.

The drive-in element 60 is, for its part, driven by a drive, which comprises a squirrel-cage rotor 90 arranged on the piston plate 70, an excitation coil 100, a soft-magnetic frame 105, a switching circuit 200 and a capacitor 300 with an internal resistance of 5 mohms. The squirrel-cage rotor 90 consists of a preferably ring-like, particularly preferably circular ring-like, element with a low electrical resistance, for example made of copper, and is fastened, for example soldered, welded, adhesively bonded, clamped or connected in a form-fitting manner, to the piston plate 70 on the side of the piston plate 70 that faces away from the holder 20. In exemplary embodiments which are not shown, the piston plate itself is formed as a squirrel-cage rotor. The switching circuit 200 is provided for causing rapid electrical discharging of the previously charged capacitor 300 and conducting the thereby flowing discharge current through the excitation coil 100, which is embedded in the frame 105. The frame preferably has a saturation flux density of at least 1.0 T and/or an effective specific electrical conductivity of at most 10⁶ S/m, so that a magnetic field generated by the excitation coil 100 is intensified by the frame 105 and eddy currents in the frame 105 are suppressed.

In a ready-to-set position of the drive-in element 60 (FIG. 1), the drive-in element 60 enters with the piston plate 70 a ring-like recess, not specifically denoted, of the frame 105 such that the squirrel-cage rotor 90 is arranged at a small distance from the excitation coil 100. As a result, an excitation magnetic field, which is generated by a change in an electrical excitation current flowing through the excitation coil, passes through the squirrel-cage rotor 90 and, for its part, induces in the squirrel-cage rotor 90 a secondary electrical current, which circulates in a ring-like manner. This secondary current, which builds up and therefore changes, in turn generates a secondary magnetic field, which opposes the excitation magnetic field, as a result of which the squirrel-cage rotor 90 is subject to a Lorentz force, which is repelled by the excitation coil 100 and drives the drive-in element 60 toward the holder 20 and also the fastening element 30 held therein.

The setting tool 10 further comprises a housing 110, in which the drive is held, a handle 120 with an operating element 130 formed as a trigger, an electrical energy store 140 formed as a rechargeable battery, a control unit 150, a tripping switch 160, a contact-pressure switch 170, as a means for detecting a temperature of the excitation coil 100, formed as a temperature sensor 180 arranged on the frame 105, and electrical connecting lines 141, 161, 171, 181, 201, 301, which connect the control unit 150 to the electrical energy store 140, to the tripping switch 160, to the contact-pressure switch 170, to the temperature sensor 180, to the switching circuit 200 and, respectively, to the capacitor 300. In exemplary embodiments which are not shown, the setting tool 10 is supplied with electrical energy by means of a power cable instead of the electrical energy store 140 or in addition to the electrical energy store 140. The control unit comprises electronic components, preferably interconnected on a printed circuit board to form one or more electrical control circuits, in particular one or more microprocessors.

When the setting tool 10 is pressed against a substrate that is not shown (on the left in FIG. 1), a contact-pressure element, not specifically denoted, operates the contact-pressure switch 170, which as a result transmits a contact-pressure signal to the control unit 150 by means of the connecting line 171. This triggers the control unit 150 to initiate a capacitor charging process, in which electrical energy is conducted from the electrical energy store 140 to the control unit 150 by means of the connecting line 141 and from the control unit 150 to the capacitor 300 by means of the connecting lines 301, in order to charge the capacitor 300. To this end, the control unit 150 comprises a switching converter, not specifically denoted, which converts the electric current from the electrical energy store 140 into a suitable charge current for the capacitor 300. When the capacitor 300 is charged and the drive-in element 60 is in its ready-to-set position illustrated in FIG. 1, the setting tool 10 is in a ready-to-set state. Since charging of the capacitor 300 is only implemented by the setting tool 10 pressing against the substrate, to increase the safety of people in the area a setting process is only made possible when the setting tool 10 is pressed against the substrate. In exemplary embodiments which are not shown, the control unit already initiates the capacitor charging process when the setting tool is switched on or when the setting tool is lifted off the substrate or when a preceding driving-in process is completed.

When the operating element 130 is operated, for example by being pulled using the index finger of the hand which is holding the handle 120, with the setting tool 10 in the ready-to-set state, the operating element 130 operates the tripping switch 160, which as a result transmits a tripping signal to the control unit 150 by means of the connecting line 161. This triggers the control unit 150 to initiate a capacitor discharging process, in which electrical energy stored in the capacitor 300 is conducted from the capacitor 300 to the excitation coil 100 by means of the switching circuit 200 by way of the capacitor 300 being discharged.

To this end, the switching circuit 200 schematically illustrated in FIG. 1 comprises two discharge lines 210, 220, which connect the capacitor 300 to the excitation coil 200 and at least one discharge line 210 of which is interrupted by a normally open discharge switch 230. The switching circuit 200 forms an electrical oscillating circuit with the excitation coil 100 and the capacitor 300. Oscillation of this oscillating circuit back and forth and/or negative charging of the capacitor 300 may potentially have an adverse effect on the efficiency of the drive, but can be suppressed with the aid of a free-wheeling diode 240. The discharge lines 210, 220 are electrically connected, for example by soldering, welding, screwing, clamping or form-fitting connection, to in each case one electrode 310, 320 of the capacitor 300 by means of electrical contacts 370, 380 of the capacitor 300 which are arranged on an end side 360 of the capacitor 300 that faces the holder 20. The discharge switch 230 is preferably suitable for switching a discharge current with a high current intensity and is formed for example as a thyristor. In addition, the discharge lines 210, 220 are at a small distance from one another, so that a parasitic magnetic field induced by them is as low as possible. By way of example, the discharge lines 210, 220 are combined to form a busbar and are held together by a suitable means, for example a retaining device or a clip. In exemplary embodiments which are not shown, the free-wheeling diode is connected electrically in parallel with the discharge switch. In further exemplary embodiments which are not shown, there is no free-wheeling diode provided in the circuit.

For the purpose of initiating the capacitor discharging process, the control unit 150 closes the discharge switch 230 by means of the connecting line 201, as a result of which a discharge current of the capacitor 300 with a high current intensity flows through the excitation coil 100. The rapidly rising discharge current induces an excitation magnetic field, which passes through the squirrel-cage rotor 90 and, for its part, induces in the squirrel-cage rotor 90 a secondary electric current, which circulates in a ring-like manner. This secondary current which builds up in turn generates a secondary magnetic field, which opposes the excitation magnetic field, as a result of which the squirrel-cage rotor 90 is subject to a Lorentz force, which is repelled by the excitation coil 100 and drives the drive-in element 60 toward the holder 20 and also the fastening element 30 held therein. As soon as the piston rod 80 of the drive-in element 60 meets a head, not specifically denoted, of the fastening element 30, the fastening element 30 is driven into the substrate by the drive-in element 60. Excess kinetic energy of the drive-in element 60 is absorbed by a braking element 85 made of a spring-elastic and/or damping material, for example rubber, by way of the drive-in element 60 moving with the piston plate 70 against the braking element 85 and being braked by the latter until it comes to a standstill. The drive-in element 60 is then reset to the ready-to-set position by a resetting tool that is not specifically denoted.

The capacitor 300, in particular its center of gravity, is arranged behind the drive-in element 60 on the setting axis A, whereas the holder 20 is arranged in front of the drive-in element 60. Therefore, with respect to the setting axis A, the capacitor 300 is arranged in an axially offset manner in relation to the drive-in element 60 and in a radially overlapping manner with the drive-in element 60. As a result, on the one hand a small length of the discharge lines 210, 220 can be realized, as a result of which their resistances can be reduced, and therefore an efficiency of the drive can be increased. On the other hand, a small distance between a center of gravity of the setting tool 10 and the setting axis A can be realized. As a result, tilting moments in the event of recoil of the setting tool 10 during a driving-in process are small. In an exemplary embodiment which is not shown, the capacitor is arranged around the drive-in element.

The electrodes 310, 320 are arranged on opposite sides of a carrier film 330 which is wound around a winding axis, for example by metallization of the carrier film 330, in particular by being vapor-deposited, wherein the winding axis coincides with the setting axis A. In exemplary embodiments which are not shown, the carrier film with the electrodes is wound around the winding axis such that a passage along the winding axis remains. In particular, in this case the capacitor is for example arranged around the setting axis. The carrier film 330 has at a charging voltage of the capacitor 300 of 1500 V a film thickness of between 2.5 μm and 4.8 μm and at a charging voltage of the capacitor 300 of 3000 V a film thickness of for example 9.6 μm. In exemplary embodiments which are not shown, the carrier film is for its part made up of two or more individual films which are arranged as layers one on top of the other. The electrodes 310, 320 have a sheet resistance of 50 ohms/□.

A surface of the capacitor 300 has the form of a cylinder, in particular a circular cylinder, the cylinder axis of which coincides with the setting axis A. A height of this cylinder in the direction of the winding axis is substantially the same size as its diameter, measured perpendicularly to the winding axis. On account of a small ratio of height to diameter of the cylinder, a low internal resistance for a relatively high capacitance of the capacitor 300 and, not least, a compact construction of the setting tool 10 are achieved. A low internal resistance of the capacitor 300 is also achieved by a large line cross section of the electrodes 310, 320, in particular by a high layer thickness of the electrodes 310, 320, wherein the effects of the layer thickness on a self-healing effect and/or on a service life of the capacitor 300 should be taken into consideration.

The capacitor 300 is mounted on the rest of the setting tool 10 in a manner damped by means of a damping element 350. The damping element 350 damps movements of the capacitor 300 relative to the rest of the setting tool 10 along the setting axis A. The damping element 350 is arranged on the end side 360 of the capacitor 300 and completely covers the end side 360. As a result, the individual windings of the carrier film 330 are subject to uniform loading by recoil of the setting tool 10. In this case, the electrical contacts 370, 380 protrude from the end surface 360 and pass through the damping element 350. For this purpose, the damping element 350 in each case has a clearance through which the electrical contacts 370, 380 protrude. The connecting lines 301 respectively have a strain-relief and/or expansion loop, not illustrated in any detail, for compensating for relative movements between the capacitor 300 and the rest of the setting tool 10. In exemplary embodiments which are not shown, a further damping element is arranged on the capacitor, for example on the end side of the capacitor that faces away from the holder. The capacitor is then preferably clamped between two damping elements, that is to say the damping elements bear against the capacitor with prestress. In further exemplary embodiments which are not shown, the connecting lines have a rigidity which continuously decreases as the distance from the capacitor increases.

FIG. 2 illustrates in the form of a detail a hand-held setting tool 410 for driving fastening elements along a setting axis A₁ (to the left in FIG. 2) into a substrate that is not shown. The setting tool 410 has a drive-in element 460, which comprises a piston plate 470 and a piston rod 480. The drive-in element 460 is guided with its piston plate 470 in a guide cylinder 495 along the setting axis A₁. The drive-in element 460 is, for its part, driven by a drive, which comprises a squirrel-cage rotor 490 arranged on the piston plate 470, an excitation coil 500, a soft magnetic frame 505, a switching circuit that is not shown and a capacitor that is likewise not shown. The setting tool 410 further comprises a housing 510, in which the drive is held. Further elements and the mode of operation of the setting tool 410 substantially correspond to those of the setting tool 10 shown in FIG. 1.

The guide cylinder 495 is of circular-cylindrical form and comprises a lateral surface which is arranged circular-symmetrically about the setting axis A₁ and has a number of non-closable openings 496, which are distributed along the setting axis A₁. During a movement of the drive-in element 460 along the setting axis A₁, the openings 496 ensure ventilation of the guide cylinder 495 in front of and behind the drive-in element 460, as a result of which a dynamic pressure in front of the drive-in element 460 and a suction pressure behind the drive-in element 460 are reduced. Between the openings 496 and the housing 510 there is an intermediate space, into which the air can escape. In exemplary embodiments which are not shown, the housing has further openings, which communicate with the openings of the guide cylinder by means of an intermediate space, by means of a flow channel or directly.

The guide cylinder 495 has a front end portion 497 and a rear end portion 498. All of the openings 496 are arranged outside the rear end portion 498, so that a closed rear cavity 499 forms in the rear end portion 498 when the drive-in element 460, in particular the piston plate 470, is located in the rear end portion 498. The guide cylinder 495 also has a rear check valve 520, which allows an air flow into the rear cavity 499 and blocks an air flow out of the rear cavity 499. As a result, the drive-in element 460 is braked during a backward movement, but not significantly during a forward movement. In exemplary embodiments which are not shown, the guide cylinder has a front check valve, which allows an air flow into the front cavity and blocks an air flow out of the front cavity.

The guide cylinder 495 is for example produced by means of a primary forming process, in particular an injection molding process. In exemplary embodiments which are not shown, the openings are punched into a flat plastic film and then the plastic film is rolled into a cylindrical shape to produce the guide cylinder, for example by hot rolling. The openings are preferably punched from a later inside of the cylinder in the direction of a later outside of the cylinder, so that no punched edges protrude into the guide cylinder. PA, with for example 30% carbon fibers and/or 15% PTFE, is used in particular as the plastic material.

FIG. 3 illustrates a longitudinal section through a guide cylinder 600 of a setting tool that is not shown any further. A lateral surface of the guide cylinder 600 has a multiplicity of openings 610, which are arranged both along a setting axis that is not shown and along a circumference around the setting axis. The guide cylinder 600 has a front end portion 620 and a rear end portion 630. All of the openings 610 are arranged outside the rear end portion 630, so that a closed rear cavity is formed in the rear end portion 630 when there is a drive-in element that is not shown in the rear end portion 630.

FIGS. 4 and 5 illustrate a longitudinal section through a drive-in element 640 in a guide cylinder 650 of a setting tool that is not shown. The drive-in element 640 comprises a piston plate 641 and a piston rod 642. A lateral surface of the guide cylinder 650 has a multiplicity of openings 660, which are arranged both along a setting axis that is not shown and along a circumference around the setting axis. The guide cylinder 650 has a front end portion 670 and a rear end portion 680. A braking element 690 for the drive-in element 640 is arranged in the guide cylinder 650, in particular in the front end portion 670. All of the openings 660 are located outside the front end portion 670.

During a movement of the drive-in element 640 along the setting axis, the openings 660 ensure venting 665 of the guide cylinder 650 in front of the piston plate 641 and ventilation behind the drive-in element 640, as a result of which a dynamic pressure in front of the drive-in element 640 and a suction pressure behind the drive-in element 640 are reduced. The braking element 690 is arranged completely in the front end portion 670, so that the piston plate 641 can enter the front end portion 670 before the drive-in element 640, in particular the piston plate 641, strikes the braking element 690. As soon as the drive-in element 640 is located in the front end portion 670, in the front end portion 670 there forms a closed front cavity 675, which is compressed by the drive-in element 640, in particular the piston plate 641, and brakes the movement of the drive-in element 640 in the manner of a gas spring. The braking element 690 is made of an elastic material, for example rubber, and also brakes the movement of the drive-in element 640 as soon as the drive-in element 640, in particular the piston plate 641, strikes the braking element 690.

FIG. 6 illustrates by way of example various forms of openings 700, 710 in a guide cylinder that is not shown any further of a setting tool that is likewise not shown any further. The openings 700 (at the top in FIG. 6) have a circular cross-sectional area and are arranged in a number of rows along a setting axis A₂. An extent of each of the openings 700 in the direction of the setting axis A₂ is therefore equal to transversely to the setting axis A₂.

The openings 710 (at the bottom in FIG. 6) are slit-shaped and are arranged in a number of rows along a setting axis A₃. A longitudinal direction of the respective slit is inclined with respect to the setting axis A₃. This angle of inclination is less than 45°, for example 25°, so that an extent of each of the openings 710 in the direction of the setting axis A₃ is greater than transversely to the setting axis.

FIG. 7 illustrates a longitudinal section through a guide cylinder 800 of a setting tool that is not shown any further. A lateral surface of the guide cylinder 800 has a plurality of openings 810, which are arranged in a row along a circumference around the setting axis. During a movement of a drive-in element that is not shown along a cylinder axis of the guide cylinder 800, the openings 810 ensure ventilation of the guide cylinder 800 in front of and/or behind the drive-in element. The openings 810 are slit-shaped, a longitudinal direction of the respective slit being aligned parallel to the setting axis. The openings 810 extend from a front end portion 820 of the guide cylinder 800 to a rear end portion 830 of the guide cylinder 800. Between the openings 810 webs 840 are formed, along which the drive-in element, in particular a piston plate of the drive-in element, is guided in a sliding manner. The present guide cylinder has four openings 810 and four webs 840, which are arranged alternately in a circumferential row. In exemplary embodiments which are not shown, more than four, three or two openings or only one opening is/are provided, arranged in one, two or more circumferential rows along the setting axis or inclined in relation to the setting axis. In order to ensure adequate guidance of the drive-in element, the individual openings should not extend over a circumferential angle of more than 180°. In further embodiments which are not shown, the openings are continuous, so that the webs are separated from one another and act as individual guide rods for the piston plate.

FIG. 8 illustrates two cross-sectional views of the guide cylinder 800 shown in FIG. 7. The sectional plane of the view on the left in FIG. 8 lies in the area of the front end portion 820 or in the area of the rear end portion 830, where no openings are arranged in each case. By contrast, the sectional plane of the view on the right in FIG. 8 lies in the area of the openings 810 and webs 840.

FIG. 9 schematically illustrates a longitudinal section through a piston plate 870 of a drive-in element that is not shown any further in a guide cylinder 850 of a setting tool that is likewise not shown any further. The drive-in element is intended to be moved along a setting axis A₄ in order to drive a fastening element that is not shown into a substrate that is likewise not shown (downward in FIG. 9). The piston plate 870 has a front side 871 and a rear side 872 and two or more passageways 880 leading from the front side 871 to the rear side 872. The passageways 880 each run in a straight line from the front side 871 to the rear side 872 and are formed as bores.

Each passageway 880 opens with a front port 881 into the front side 871 and with a rear port 882 into the rear side 872. In a region of the rear port 882, the passageway 880 defines a flow axis S for an air flow, which leaves the passageway 880 through the rear port 882. The flow axis S runs parallel to the setting axis A₄. The passageway 880 allows an air flow from the front port 881 to the rear port 882, and vice versa, and ensures pressure equalization between the front side 871 and the rear side 872. As a result, a dynamic pressure in front of the piston plate 870 and/or a suction pressure behind the piston plate 870 and a concomitant loss of energy are reduced.

FIG. 10 schematically illustrates a drive-in element 910 in a guide cylinder 900 of a setting tool that is not shown any further. The drive-in element 910 comprises a piston plate 911 and a piston rod 912. The guide cylinder 900 has a front end portion 920. A braking element 930 for the drive-in element 910 is arranged in the guide cylinder 900, in particular in the front end portion 920. The drive-in element 910 is intended to be moved along a setting axis A₅ in order to drive a fastening element that is not shown into a substrate that is likewise not shown (downward in FIG. 10). The piston plate 911 has a front side 921 and a rear side 922 and two or more passageways 940 leading from the front side 921 to the rear side 922. Each passageway 940 opens with a front port 941 into the front side 921 and with a rear port 942 into the rear side 922.

In order for example to reduce excess kinetic energy of the drive-in element 910, the drive-in element 910 is braked by the braking element 930. FIG. 10 shows the drive-in element 910 at the point in time at which the piston plate 911 strikes the braking element 930. The piston plate 911 has a contact surface 915, which surrounds the setting axis A₅ in an annular manner and contacts the braking element 930. At this point in time, the piston plate 911 is arranged in the front end portion 920. The front port 941 of each passageway 940 is arranged radially within the contact surface 915 with respect to the setting axis A₅, so that in the front end portion 920 there forms radially outside the braking element 930 a closed front cavity 935, which is compressed by the drive-in element 910, in particular the piston plate 911, and additionally brakes the movement of the drive-in element 910 in the manner of a gas spring. The braking element 930 is in particular made of an elastic material, for example rubber.

FIG. 11 schematically illustrates a longitudinal section through a piston plate 970 of a drive-in element that is not shown any further in a guide cylinder 950 of a setting tool that is likewise not shown any further. The drive-in element is intended to be moved along a setting axis A₆ in order to drive a fastening element that is not shown into a substrate that is likewise not shown (downward in FIG. 11). The piston plate 970 has a front side 971 and a rear side 972 and two or more passageways 980 leading from the front side 971 to the rear side 972.

Each passageway 980 opens with a front port 981 into the front side 971 and with a rear port 982 into the rear side 972. In a region of the rear port 982, the passageway 980 defines a flow axis S′ for an air flow, which leaves the passageway 980 through the rear port 982. The flow axis S′ is inclined in relation to the setting axis A₆, so that the air flow is directed onto a lateral surface of the guide cylinder 950. A point of intersection P of the flow axis S′ with the setting axis A₆ is arranged in front of the piston plate 970.

FIG. 12 illustrates a plan view of a piston plate 990 of a drive-in element that is not shown any further. The piston plate 990 has a front side, which is not visible, and a rear side 992 and four passageways 995 leading from the front side to the rear side 992. Each of the four passageways 995 opens with a front port 996 into the front side and with a rear port 997 into the rear side 992. In a region of the rear port 997, each passageway 995 defines a flow axis, which does not lie in the plane of the drawing of FIG. 12, for an air flow, which leaves the passageway 995 through the rear port 997. The flow axis and a setting axis running perpendicularly to the plane of the drawing are skewed in relation to one another. The arrangement and alignment of the passageways 995 shown in FIG. 12 have the effect of producing an air flow rotating about the setting axis, as a result of which cooling of a guide cylinder that is not shown is improved. Under certain circumstances, a rotation of the piston plate 990 is caused, so that abrasion of an outer edge 999 of the piston plate 990 is evened out and wear of the piston plate 990 is reduced.

FIG. 13 illustrates a plan view of a piston plate 1,090 of a drive-in element that is not shown any further. The piston plate 1,090 has a front side, which is not visible, and a rear side 1,092 and four passageways 1,095 leading from the front side to the rear side 1,092. Each of the four passageways 1095 is formed by a recess on an outer edge 1099 of the piston plate 1090. A skewed alignment of the passageways 1095, as in the exemplary embodiment shown in FIG. 12, has the effect of producing an air stream rotating about the setting axis, as a result of which cooling of a guide cylinder that is not shown is improved. In exemplary embodiments which are not shown, the passageways formed by cutouts are aligned parallel to one another and/or to a setting axis.

The invention has been described using a series of exemplary embodiments that are illustrated in the drawings and exemplary embodiments that are not illustrated. The individual features of the various exemplary embodiments are applicable individually or in any desired combination with one another, provided that they are not contradictory. It should be noted that the setting tool according to the invention can also be used for other applications.

1. A setting tool for driving fastening elements into a substrate, comprising a holder for holding a fastening element; a drive-in element for transferring a fastening element held in the holder into the substrate along a setting axis; a drive for driving the drive-in element toward the fastening element along the setting axis; and, a guide cylinder in which the drive-in element is guided along the setting axis, a lateral surface of the guide cylinder having one or more non-closable openings.

2. The setting tool as claimed in claim 1, wherein at least one of the one or more non-closable openings comprises a slot.

3. The setting tool as claimed in claim 2, wherein a longitudinal direction of the slot is parallel to the setting axis.

4. The setting tool as claimed in claim 2, wherein a longitudinal direction of the slot is inclined with respect to the setting axis.

5. The setting tool as claimed in claim 1, wherein an extent of at least one of the one or more non-closable openings in a direction of the setting axis is greater than transversely to the setting axis.

6. The setting tool as claimed in claim 1, wherein the lateral surface has a number of non-closable openings, which are distributed along the setting axis.

7. The setting tool as claimed in claim 1, wherein the drive-in element comprises a piston plate and a piston rod, the piston plate being guided in the guide cylinder.

8. The setting tool as claimed in claim 5, wherein, in the direction of the setting axis, the holder is arranged in front of the piston rod and the piston plate behind the piston rod.

9. The setting tool as claimed in claim 1, wherein the guide cylinder has a front end portion on its side facing the holder, all non-closable openings being arranged outside the front end portion, and a closed front cavity being formed in the front end portion when the drive-in element is located in the front end portion.

10. The setting tool as claimed in claim 7, wherein the guide cylinder has a front check valve, which allows an air flow into a front cavity and blocks an air flow out of the front cavity.

11. The setting tool as claimed in claim 1, wherein the guide cylinder has a rear end portion on its side facing away from the holder, all non-closable openings being arranged outside the rear end portion, and a closed rear cavity being formed in the rear end portion when the drive-in element is located in the rear end portion.

12. The setting tool as claimed in claim 9, wherein the guide cylinder has a rear check valve, which allows an air flow into a rear cavity and blocks an air flow out of the rear cavity.

13. The setting tool as claimed in claim 1, wherein the drive has an electrical capacitor, a squirrel-cage rotor arranged on the drive-in element and an excitation coil, wherein current flows through the capacitor during discharge of the capacitor and the excitation coil generates a magnetic field that accelerates the drive-in element toward the fastening element.

14. The setting tool of claim 1, comprising a hand-held setting tool.

15. The setting tool of claim 9, wherein the piston plate of the drive-in element is located in the front portion.

16. The setting tool of claim 11, wherein the piston plate of the drive-in element is located in the rear-end portion.

17. The setting tool as claimed in claim 2, wherein an extent of at least one of the one or more non-closable openings in the direction of the setting axis is greater than transversely to the setting axis.

18. The setting tool as claimed in claim 3, wherein an extent of at least one of the one or more non-closable openings in the direction of the setting axis is greater than transversely to the setting axis.

19. The setting tool as claimed in claim 4, wherein an extent of at least one of the one or more non-closable openings in the direction of the setting axis is greater than transversely to the setting axis.

20. The setting tool as claimed in claim 2, wherein the lateral surface has a number of non-closable openings, which are distributed along the setting axis.
